(19) United States
(12) Patent Application Publication
(10) Pub. No.: US 2009/0247069 A1
(43) Pub. Date: Oct. 1, 2009

(54) REPEATER AND MOBILE STATION

(75) Inventor: Shigeo SATO, Tokyo (JP)

Correspondence Address: INTELLECTUAL PROPERTY / TECHNOLOGY LAW, PO BOX 14329, RESEARCH TRIANGLE PARK, NC, 27709, US

(73) Assignee: Uniden Corporation, Tokyo (JP)

(21) Appl. No.: 12/131,065

(22) Filed: May 31, 2008

(30) Foreign Application Priority Data
Apr. 1, 2008 (JP) 2008-095041

(51) Int. Cl. H04B 17/02

(52) U.S. Cl. 455/9

(57) ABSTRACT

A repeater amplifies and relays radio waves sent and received between a base station and a mobile station. The repeater includes an evaluation function calculator which, with the base station and one or more other repeaters serving as communication partners, calculates an evaluation function for evaluating the state of communication between the communication partners and the repeaters, for each of the communication partners; and a processing device which automatically determines to which of the communication partners a link is to be made on the basis of the evaluation function.

### CROSS-REFERENCES TO RELATED APPLICATIONS

This application relates to and claim priority from Japanese Patent Application No. 2008-095041, filed on Apr. 1, 2008, the entire disclosure of which is incorporated herein by reference.

### BACKGROUND

The present invention relates to a repeater and a mobile station for automatically connecting a base station and a plurality of repeaters by means of the optimum connection method.

A digital cordless telephone often employs Time Division Multiple Access (TDMA) as the multiplexing system and is provided with a repeater function which uses slots in TDMA frames. The repeaters receive and amplify radio waves from the base station and mobile stations so that the mobile stations are able to communicate wirelessly in locations remote from the base station where radio waves are weak and the repeaters retransmit these radio waves. As a result, the range of the network over which wireless communications are possible can be enlarged. There are three types of connection methods for connecting the base station and a plurality of repeaters, namely, a star connection, a daisy chain connection, and a star and daisy chain mixed connection.

### SUMMARY

However, conventionally, the user has had to employ special software in order to establish the optimum connection method from among the star connection, daisy chain connection, and star and daisy chain mixed connection and such a practice has proved insufficient in order to provide an operating environment where repeaters are installed anywhere in any way.

Therefore, an object of the present invention is to provide a repeater for automatically connecting a base station and a plurality of repeaters by means of the optimum connection method. A further object of the present invention is to provide a mobile station which provides information indicating whether a location is a suitable location for the installation of a repeater after the installation location of the repeater has been changed.

In order to achieve the above objects, the repeater according to the present invention is a repeater which amplifies and relays radio waves sent and received between a base station and a mobile station, the repeater comprising an evaluation function calculator which, with the base station and one or more other repeaters serving as communication partners, calculates an evaluation function for evaluating the state of communication between the communication partners and the repeater, for each of the communication partners; and a processing device which automatically determines to which of the communication partners a link is to be made on the basis of the evaluation function.

The repeater according to the present invention makes it possible to automatically determine which connection method of the star connection and daisy chain connection is used to link to which communication partner on the basis of the evaluation function and the user is therefore able to suitably connect the base station and plurality of repeaters without using dedicated software.

Here, in cases where there is only one communication partner for which the value of the evaluation function is equal to or more than a predetermined threshold value, the processing device determines that a link is to be made to the one communication partner. Further, in cases where a plurality of communication partners for which the value of the evaluation function is equal to or more than a predetermined threshold value exist, the processing device determines that a link is to be made to the communication partner with the smallest number of repeaters (connect number) that exists on the link between the repeaters for which the base station is the starting point, among the plurality of communication partners. The repeater is able to avoid a drop in call quality due to the production of near-end echo by linking to the communication partner with the smallest connect number.

As long as the evaluation function is a function that allows the call quality to be evaluated, any functions can be used without particular restrictions. For example, the evaluation function is preferably a function which outputs a received signal strength indicator when the bit error rate of the communications between the communication partner and the repeater reaches a predetermined value. The received signal strength indicator has the goal of evaluating the call quality.

The automatic connection function of the repeater may also be installed in a charger for the purpose of charging a mobile station. Since one charger is normally provided in one mobile station, convenience can be improved by installing the automatic connection function of the repeater in the charger.

The mobile station according to the present invention is a mobile station which communicates wirelessly with a base station via a repeater, comprising an evaluation function calculator which, with the base station and one or more repeaters serving as communication partners, calculates an evaluation function for evaluating the state of communication between the communication partners and the mobile station, for each of the communication partners; and a display device which displays whether the evaluation function exceeds a predetermined threshold value for each of the communication partners.

The user is able to discriminate whether the value of the evaluation function for evaluating the state of communication between the current point of the mobile station and the communication partner is equal to or more than the threshold value by referencing the information displayed on the display device, and can therefore be helpful in determining the installation position of the repeaters.

According to the present invention, a repeater for automatically connecting the base station and a plurality of repeaters by means of the optimum connection method can be proposed. Furthermore, according to the present invention, a mobile station which provides information indicating whether a location is a suitable location for the installation of a repeater after the installation location of the repeater has been changed can be proposed.

### DESCRIPTION OF THE DRAWINGS

FIG. 1 is an explanatory diagram of a star connection;

FIG. 2 is an explanatory diagram of a daisy chain connection;

FIG. 3 is an explanatory diagram of a star and daisy chain mixed connection;

FIG. 4 is a function block diagram of a repeater according to this embodiment;

FIG. 5 is a flowchart which shows automatic connection processing according to this embodiment;

FIG. 6 is an explanatory diagram which shows an example of the arrangement of a plurality of repeaters;

FIG. 7 is an explanatory diagram which shows an example of the arrangement of a base station and a plurality of repeaters;

FIG. 8 is an explanatory diagram which shows an example of the arrangement of a base station and a plurality of repeaters; and

FIG. 9 is a function block diagram of a mobile station according to this embodiment.

### DETAILED DESCRIPTION

Embodiments of the present invention will be described hereinbelow with reference to the drawings.

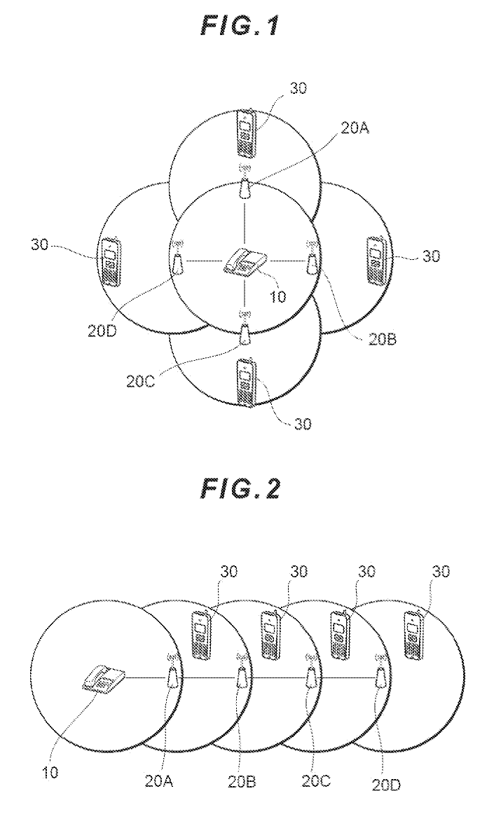

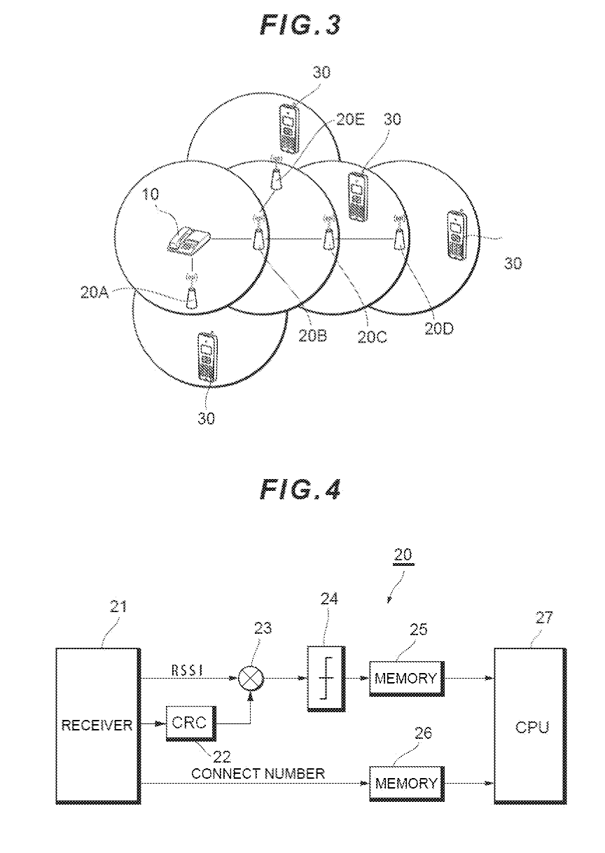

FIG. 1 is an explanatory diagram which shows an example of a star connection. FIG. 2 is an explanatory diagram which shows an example of daisy chain connection. FIG. 3 is an explanatory diagram of a star and daisy chain mixed connection. In FIG. 1, four repeaters 20A, 20B, 20C, and 20D are connected with a star connection with the base station 10 at the center thereof. In FIG. 2, four repeaters 20A, 20B, 20C, and 20D are connected with a daisy chain connection, where the base station 10 is the starting point. In FIG. 3, two repeaters 20A and 20B are connected with a star connection with the base station 10 at the center thereof and two repeaters 20C and 20E are connected with a star connection with the repeater 20B at the center thereof, and repeater 20D is connected to repeater 20C via a daisy chain connection. In a star and daisy chain mixed connection, the star connection and the daisy chain connection are mixed. In FIGS. 1 to 3, the repeaters 20A, 20B, 20C, 20D, and 20E (when there is no need to distinguish between the repeaters 20A, 20B, 20C, 20D, and 20E hereinbelow, the general term ‘repeater 20’ is used) each amplify and relay radio waves which are sent and received between the base station 10 and mobile stations 30. The mobile stations 30 communicate with the base station 10 by utilizing the communication range which has been enlarged by the repeaters 20.

In the automatic connection processing according to this embodiment, the repeaters 20 each calculates an evaluation function for evaluating the communication state with the communication partners (the base station 10 and one or more other repeaters 20). As long as the evaluation function is a function that outputs a high enough value for a favorable communication state between the repeaters 20 and their communication partners, there are no restrictions on the evaluation function and optional functions can be used. When it is judged that the value of the evaluation function is equal to or more than a predetermined threshold value, a repeater 20 judges that same is located within the communication area of the communication partner. However, when the value of the evaluation function is less than a predetermined threshold value, it is judged that the repeater 20 is located outside the communication area of the communication partner. In cases where there is only one communication partner for which the value of the valuation function is equal to or more than the threshold value, the repeater 20 is linked by means of a daisy chain connection to the communication partner. However, in cases where there is a plurality of communication partners for which the value of the valuation function is equal to or more than the threshold value, the repeater 20 selects the communication partner with the smallest connect number among the plurality of communication partners and links to the selected communication partner by means of a star connection. The repeater 20 is able to avoid a drop in the communication quality due to the production of near-end echo by linking to the communication partner with the smallest connect number. In cases where the numbers of connects of all the communication partners are equal, the repeater 20 selects the communication partner with the highest evaluation function value among the communication partners and links to the selected communication partner by means of a star connection. The position of the repeater 20 is not fixed and can change depending on the user's usage environment. Hence, the repeater 20 calculates the evaluation function with the communication partner over a fixed cycle interval and links to the optimum communication partner by means of the optimum connection method. The mobile station 30 connects to the repeater 20 with the smallest connect number among the plurality of repeaters 20 that exist in the communication area and communicates with the base station 10 via the connected repeater 20.

The connect number is a numeral which indicates which repeater 20 the connection is to, where the base station 10 is the starting point. For example, the connect numbers of the repeaters 20A, 20B, 20C, and 20D shown in FIG. 1 are all ‘1’. The connect numbers of the repeaters 20A, 20B, 20C, and 20D shown in FIG. 2 are ‘1’, ‘2’, ‘3’, and ‘4’ respectively. The connect numbers of the repeaters 20A, 20B, 20C, 20D, and 20E shown in FIG. 3 are ‘1’, ‘1’, ‘2’, ‘3’, and ‘2’ respectively. The connect number of the base station 10 is ‘0’. The repeaters 20 each obtain the connect number of the communication partners by sending and receiving the connect numbers to and from one another.

In this embodiment, a function which outputs an RSSI (Received Signal Strength Indicator) value when the CRC (Cyclic Redundancy Check) error rate is less than 1% and which outputs 0 when the CRC error rate is equal to or more than 1% is defined as the evaluation function. In addition, the RSSI value when the bit error rate is 3×10⁻⁵ is defined as a threshold value EVth. The fact that the bit error rate is equal to or more than 3×10⁻⁵ is the minimum condition for performing stable communications. However, the evaluation function and threshold value mentioned above are purely examples and other evaluation functions and threshold values can be used. For example, the decision of whether a unique word for establishing synchronization between mobile stations or a predetermined bit pattern that is determined beforehand can be normally received is the evaluation function and the reception success rate may be the threshold value.

FIG. 4 is a function block diagram of the repeater 20 according to this embodiment.

The repeater 20 comprises a receiver 21, a CRC judgment device 22, a multiplier 23, a threshold value judgment device 24, memories 25 and 26, and a CPU 27. Upon receipt of the wireless radio waves from the communication partners, the receiver 21 calculates the RSSI and CRC and obtains the connect number sent by the communication partners. The CRC judgment device 22 receives the CRC error rate which is output by the receiver 21, outputting ‘1’ if the CRC error rate is less than 1% and outputting ‘0’ if the CRC error rate is equal to or more than 1%. The multiplier 23 multiples the RSSI value output by the receiver 21 by the value output by the CRC judgment device 22 and calculates the value of the evaluation function. The functions of an evaluation function calculator are implemented as a result of the co-operation between the receiver 21, CRC judgment device 22, and the multiplier 23. The threshold value judgment device 24 compares the evaluation function value which is output by the multiplier 23 with a threshold value and stores the result of the comparison in the memory 25. The memory 26 stores the connect number which is output by the receiver 21. The CPU 27 is a processing device which uses the result of the comparison stored in the memory 25 and the connect number stored in the memory 26 to select the optimum communication partner and determines that a link is to be established to the selected communication partner by means of the optimum connection method of the star connection and daisy chain connection. In FIG. 4, although the flow of processing is associated with the respective blocks for the sake of expediency in the description, a single CPU may also carry out all of the processing. Further, an automatic connection function (the respective functions of the receiver 21, CRC judgment device 22, multiplier 23, threshold value judgment device 24, memories 25 and 26, and CPU 27) may be installed in a charger for charging the battery built into the mobile stations 30.

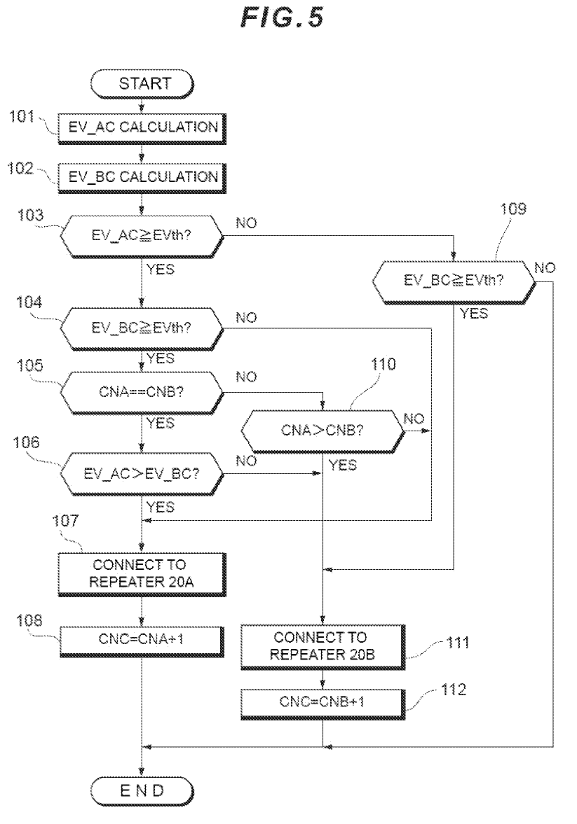

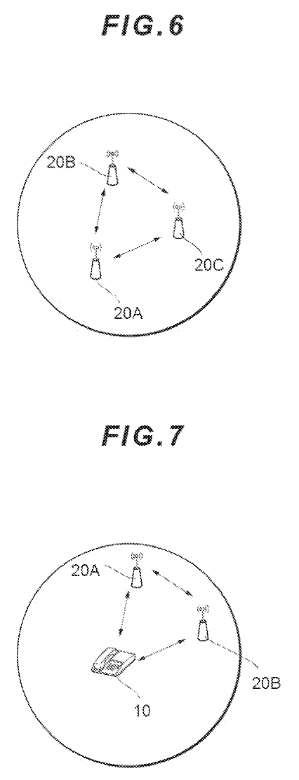

The automatic connection processing according to this embodiment will be described next with reference to FIGS. 5 and 6. In FIG. 6, a case is assumed where the repeaters 20A and 20B are already connected by means of a star connection or daisy chain connection to a communication partner (the base station or another one or more repeaters) and repeater 20C is newly connected to the network.

The repeater 20C processes a value EV_AC of the evaluation function for evaluating the communication state between the repeater 20A and repeater 20C (step 101) and subsequently processes a value EV_BC of the evaluation function for evaluating the communication state between repeater 20B and repeater 20C (step 102). The repeater 20C then judges whether EV_AC is equal to or more than the threshold value EVth in order to judge whether repeater 20C is located in the communication area of the repeater 20A (step 103). In cases where EV_AC is equal to or more than the threshold value EV_AC (step 103; YES), it is known that repeater 20C exists in the communication area of the repeater 20A. Therefore, the repeater 20C now judges whether EV-BC is equal to or more than the threshold value EVth in order to judge whether repeater 20C is located in the communication area of the repeater 20B (step 104). In cases where EV-BC is equal to or more than threshold value EVth (step 104: YES), it is known that repeater 20C exists in the communication area of repeater 20B.

Further, in cases where the repeater 20C is located in the communication areas of both repeaters 20A and 20B, repeater 20C judges whether the connect number CNA of the repeater 20A and the connect number CNB of repeater 20B are the same in order to select the repeater with the smallest connect number (step 105). In cases where the connect number CNA and connect number CNB are the same (step 105; YES), because relative merits cannot be assigned using the connect number alone, the repeater 20C compares the evaluation function value EV_AC and evaluation function value EV_BC in order to select a communication partner with a favorable communication state (step 106). In cases where the evaluation function value EV_AC is equal to or more than the evaluation function value EV_BC (step 106; YES), the state of communication between the repeaters 20A and 20C is more favorable than the state of communication between the repeaters 20B and 20C. Hence, repeater 20C links to repeater 20A by means of a star connection (step 107) and the connect number CNC of repeater 20C is CNA+1 (step 108). In cases where the evaluation function value EV_AC is less than evaluation function value EV_BC (step 106: NO), the state of communication between repeaters 20B and 20C is more favorable than the state of communication between repeaters 20A and 20C. Hence, repeater 20C links to repeater 20B by means of a star connection (step 111) and the connect number CNC of repeater 20C is CNB+1 (step 112).

However, in cases where the evaluation function value EV_AC is less than the threshold value EVth (step 103; NO), repeater 20C judges that the repeater 20C is located outside the communication area of the repeater 20A. Thereafter, the repeater 20C judges whether the evaluation function value EV_BC is equal to or more than threshold value EVth in order to judge whether the repeater 20C is located in the communication area of the repeater 20B (step 109). In cases where the EV_BC is equal to or more than the threshold value EVth (step 109; YES), the repeater 20C judges that the repeater 20C exists in the communication area of the repeater 20B and links to the repeater 20B by means of a daisy chain connection (step 111) and the connect number CNC of the repeater 20C is the CNB+1 (step 112).

Conversely, in cases where the evaluation function value EV_AC is equal to or more than threshold value EVth (step 103: YES) and the evaluation function value EV_BC is less than the threshold value EVth (step 104; NO), the repeater 20C exists in the communication area of the repeater 20A and exists outside the communication area of the repeater 20B, and steps 107 and 108 are therefore executed.

In addition, in cases where the evaluation function value EV_AC is equal to or more than the threshold value EVth (step 103; YES) and the evaluation function value EV_BC is equal to or more than the threshold value EVth (step 104; YES) and where the connect number CNA and connect number CNB are not the same (step 105; NO), the repeater 20C judges whether the connect number CNA is greater than the connect number CNB (step 110). In cases where the connect number CNA is greater than the connect number CNB (step 110: YES), the repeater 20C links to the repeater 20B with a small connect number by means of a star connection (step 111) and the connect number CNC of repeater 20C is CNB+1 (step 112). In cases where the connect number CNA is smaller than the connect number CNB (step 110: NO), the repeater 20C links to the repeater 20A with a small connect number by means of the star connection (step 107), and the connect number CNC of the repeater 20C is CNA+1 (step 108).

In cases where the evaluation function value EV_AC is less than the threshold value EVth (step 103; NO) and where the evaluation function value EV_BC is less than the threshold value EVth (step 109; NO), the repeater 20C exists outside the communication area of both the repeaters 20A and 20B and ends the automatic connection processing.

The automatic connection processing of this embodiment makes it possible to automatically determine which connection method of the star connection and daisy chain connection is used to link to which communication partner on the basis of the evaluation function and the user is therefore able to suitably connect the base station 10 and plurality of repeaters 20 without using dedicated software.

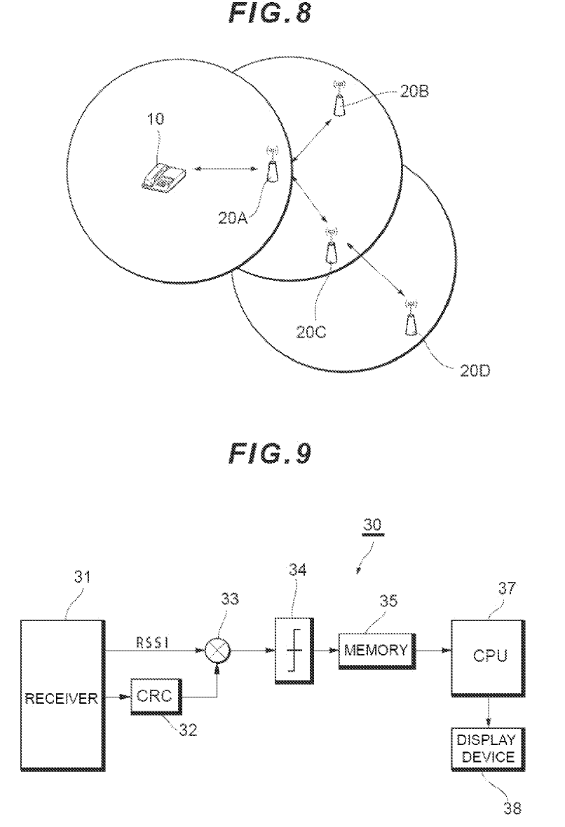

Another connection example will be described next with reference to FIGS. 7 and 8.

FIG. 7 shows an example of a star connection where the base station 10 is at the center. In the example shown in FIG. 7, both the evaluation function value which indicates the state of communication between the base station 10 and the repeater 20A and the evaluation function value which indicates the state of communication between the base station 10 and the repeater 20B are equal to or more than the threshold value EVth, the repeater 20A judges that there is no need to link to the repeater 20B by means of a daisy chain connection and links to the base station 10 by means of a star connection. Likewise, the repeater 20B judges that there is no need to link to the repeater 20A by means of a daisy chain connection and links to the base station 10 by means of a star connection. Supposing that the repeaters 20A and 20B link to the base station 10 by means of a daisy chain connection, in comparison with a case where each of the repeaters 20A and 20B are connected to the base station 10 by means of a star connection, a narrowing of the communication area takes place, which is undesirable. In cases where a mobile station 30 is located in the communication area of the base station 10, the mobile station 30 connects to the base station 10 which has the smallest connect number among the repeaters 20A and 20B and base station 10 located in the communication area.

FIG. 8 shows an example of a star and daisy chain mixed connection. In the example shown in FIG. 8, although the value of the evaluation function between the repeater 20A and repeater 20B and the value of the evaluation function between the repeater 20A and repeater 20C are both equal to or more than the threshold value EVth, because the value of the evaluation function between the repeater 20B and base station 10 and the value of the evaluation function between the repeater 20C and base station 10 is less than the threshold value EVth, it is judged that each of the repeaters 20B and 20C are themselves located in the communication area of the repeater 20A but not located in the communication area of the base station 10, and the repeaters 20B and 20C link to repeater 20A by means of a star connection.

Furthermore, in cases where the value of the evaluation function between the repeater 20D and repeater 20C is equal to or more than the threshold value EVth but the value of the evaluation function between the base station 10 and repeater 20D, the value of the evaluation function between the repeater 20A and repeater 20D, and the value of the evaluation function between repeater 20B and repeater 20D are all less than threshold value EVth, it is judged that the repeater 20D is located in the communication area of repeater 20C but not located in the communication areas of the base station 10 and repeaters 20A and 20B, and the repeater 20D links to the repeater 20C by means of a daisy chain connection. In cases where a mobile station 30 is located in the communication area of the repeater 20A, the mobile station 30 is connected to the repeater 20A with the smallest connect number among the repeaters 20A, 20B, and 20C which are located in the communication area.

FIG. 9 is a function block diagram of the mobile station 30 according to this embodiment.

The mobile station 30 comprises a receiver 31, a CRC judgment device 32, a multiplier 33, a threshold value judgment device 34, memory 35, a CPU 37, and a display device 38. The respective functions of the receiver 31, CRC judgment device 32, multiplier 33, threshold value judgment device 34, memory 35, and CPU 37 are the same as the respective functions of the earlier mentioned receiver 21, CRC judgment device 22, multiplier 23, threshold value judgment device 24, memory 25, and CPU 27 and a detailed description of the former will therefore be omitted here. The functions of an evaluation function calculator are implemented as a result of the co-operation of the receiver 31, CRC judgment device 32, and multiplier 33. The display device 38 displays the result of a comparison between a threshold value and the value of the evaluation function for evaluating the state of communication between the mobile station 30 and communication partner. The displaying of the comparison result may take the form of a character display, for example, or may be an encoded display of the number of antennas. The display device 38 may also display the fact that the value of the evaluation function exceeds the threshold value by igniting a light-emitting diode. The user is able to discriminate whether the value of the evaluation function for evaluating the state of communication between the current point in which mobile station 30 is located and the communication partner is equal to or more than the threshold value by referencing the comparison result displayed on the display device 38, and can therefore be helpful in determining the installation position of the repeaters 20.

What is claimed is:

1. A repeater which amplifies and relays radio waves sent and received between a base station and a mobile station, the repeater comprising:
an evaluation function calculator which, with the base station and one or more other repeaters serving as communication partners, calculates an evaluation function for evaluating a state of communication between the communication partners and the repeater, for each of the communication partners; and
a processing device which automatically determines to which of the communication partners a link is to be made on the basis of the evaluation function.

2. The repeater according to claim 1, wherein
in cases where only one communication partner for which the value of the evaluation function is equal to or more than a predetermined threshold value exists, the processing device determines that a link is to be made to the one communication partner; and
in cases where a plurality of communication partners for which the value of the evaluation function is equal to or more than a predetermined threshold value exist, the processing device determines that a link is to be made to a communication partner with the smallest number of repeaters that exists on the link between the repeaters for which the base station is the starting point, among the plurality of communication partners.

3. The repeater according to claim 1, wherein the evaluation function is a function which outputs a received signal strength indicator when a bit error rate of the communications between the communication partner and the repeater reaches a predetermined value.

4. The repeater according to claim 1, wherein the repeater is a charging device for charging the mobile station.

5. A mobile station which communicates wirelessly with a base station via a repeater, comprising:
an evaluation function calculator which, with the base station and one or more other repeaters serving as communication partners, calculates an evaluation function for evaluating a state of communication between the communication partners and the mobile station, for each of the communication partners; and
a display device which displays whether the evaluation function exceeds a predetermined threshold value for each of the communication partners.
